(19) United States
(12) Patent Application Publication
(10) Pub. No.: US 2024/0339261 A1
(43) Pub. Date: Oct. 10, 2024

(54) COIL COMPONENT

(71) Applicant: SAMSUNG ELECTRO-MECHANICS CO., LTD., Suwon-si (KR)

(72) Inventors: Jae Hun Kim, Suwon-si (KR); Boum Seock Kim, Suwon-si (KR); Ju Hwan Yang, Suwon-si (KR); Su Min Seo, Suwon-si (KR); Doo Ho Park, Suwon-si (KR)

(73) Assignee: SAMSUNG ELECTRO-MECHANICS CO., LTD., Suwon-si (KR)

(21) Appl. No.: 18/589,828

(22) Filed: Feb. 28, 2024

(30) Foreign Application Priority Data
Apr. 6, 2023 (KR) 10-2023-0045578

(51) Int. Cl. H01F 27/32; H01F 27/06; H01F 27/28; H01F 27/29

(52) U.S. Cl. CPC H01F 27/323; H01F 27/06; H01F 27/2804; H01F 27/292; H01F 2027/2809

(57) ABSTRACT

A coil component includes a body, a support member disposed within the body, a coil disposed on at least one of a first surface and a second surface of the support member opposing each other, and an external electrode disposed on the body and connected to the coil, wherein the support member includes a first layer and a second layer respectively including polyimide, and an average surface roughness of the surface of the support member on which the coil is disposed is 0.1 to 0.5 μm in Ra value.

### CROSS-REFERENCE TO RELATED APPLICATION(S)

This application claims benefit of priority to Korean Patent Application No. 10-2023-0045578 filed on Apr. 6, 2023 in the Korean Intellectual Property Office, the disclosure of which is incorporated herein by reference in its entirety.

### TECHNICAL FIELD

The present disclosure relates to a coil component.

With the miniaturization and thinning of electronic devices, such as digital TVs, mobile phones, laptops, etc., coil components applied to these electronic devices have also been required to be miniaturized and thinned, and in order to meet these requirements, research and development of various types of coil components, including winding-type or thin film-type coil components, have been actively underway.

The main issue with the miniaturization and thinning of coil components is maintaining the same level of characteristics as those of the conventional ones despite the miniaturization and thinning. In order to meet the requirements, the ratio of a magnetic material in a core filled with the magnetic material needs to increase, but there is a limit to increasing the ratio due to changes in frequency characteristics depending on the strength of a body and insulation.

Meanwhile, there are many attempts to reduce the thickness of coil components in terms of miniaturization, but a reduction in the thickness of the body may deteriorate the magnetic properties of the coil components. In other words, the reduction in the thickness of the body may lead to a reduction in the thickness of upper and lower cover regions of coils, and as a result, flow of magnetic flux in the cover region may not be smooth. In addition, if the thickness of a support member is reduced, it may be difficult to stably support the coil, which may degrade structural stability of the coil components.

### SUMMARY

An aspect of the present disclosure is to provide a coil component that is advantageous for miniaturization and has improved structural stability.

According to an aspect of the present disclosure, a coil component includes a body, a support member disposed within the body, the support member having a first surface and a second surface opposing each other, a coil disposed on at least one of the first surface and the second surface of the support member, and an external electrode disposed on the body and connected to the coil, wherein the support member includes a first layer and a second layer respectively including polyimide, and a first average surface roughness, Ra, of the surface of the support member on which the coil is disposed is 0.1 to 0.5 μm.

A thickness of the support member may be 5 μm or more and less than 10 μm.

The support member may include a plurality of the first layers.

The second layer may be disposed between the plurality of first layers.

The coil may be disposed on a surface of the plurality of first layers.

The first layer may be a thermoplastic polyimide layer.

The second layer may be a polyimide layer.

A second average surface roughness, Rz, of the surface of the support member on which the coil may be disposed is 1.0 to 2.5 μm.

The coil may have a multilayer structure including a first coil layer and a second coil layer.

The first coil layer may be in contact with the at least one of the first surface and the second surface of the support member.

The first coil layer may fill an uneven portion of the at least one of the first surface and the second surface of the support member.

The first coil layer may be a sputtered layer.

The second coil layer may be a plated layer.

An average width of the coil may be 80 μm or less.

An average aspect ratio of the coil may be greater than 2.

According to another aspect of the present disclosure, a coil component includes a body, a support member disposed within the body, the support member having a first surface and a second surface opposing each other, a coil disposed on at least one of the first surface and the second surface of the support member, and an external electrode disposed on the body and connected to the coil, wherein the support member includes a first layer and a second layer respectively including polyimide, and an average surface roughness, Rz, of the surface of the support member on which the coil is disposed is 1.0 to 2.5 μm.

The first layer and the second layer may have the same thickness.

A thickness of the support member may be 5 μm or more and less than 10 μm.

The first layer may include a thermoplastic polyimide layer.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a transparent perspective view schematically illustrating a coil component according to an exemplary embodiment in the present disclosure;

FIG. 2 is a partially enlarged view of FIG. 1 and is an assembly diagram illustrating a connection relationship between components;

FIG. 3 is an enlarged plan view illustrating a region of FIG. 1;

FIG. 4 is a partially enlarged view of FIG. 2;

FIGS. 5 and 6 illustrate coil components according to modified examples.

### DETAILED DESCRIPTION

Hereinafter, exemplary embodiments of the present inventive concept will be described in detail with reference to the accompanying drawings. The inventive concept may, however, be exemplified in many different forms and should not be construed as being limited to the specific exemplary embodiments set forth herein. Rather, these exemplary embodiments are provided so that this disclosure will be thorough and complete, and will fully convey the scope of the inventive concept to those skilled in the art. In the drawings, the shapes and dimensions of elements may be exaggerated for clarity, and the same reference numerals will be used throughout to designate the same or like elements.

Various types of electronic components are used in electronic devices, and various types of coil components may be appropriately used between these electronic components for the purpose of noise removal, etc. In other words, coil components in electronic devices may be used as power inductors, high frequency (HF) inductors, general beads, GHz beads, common mode filters, etc.

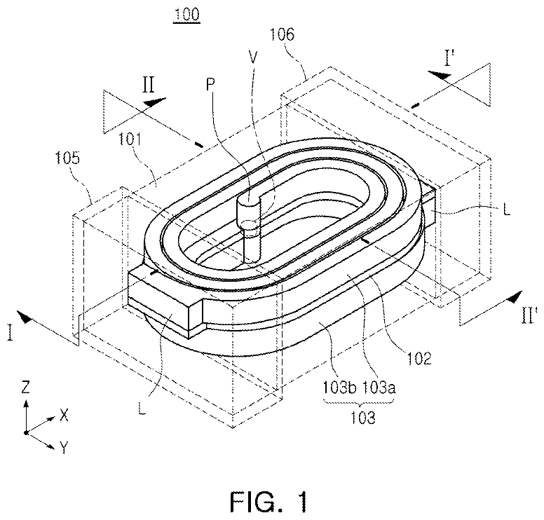

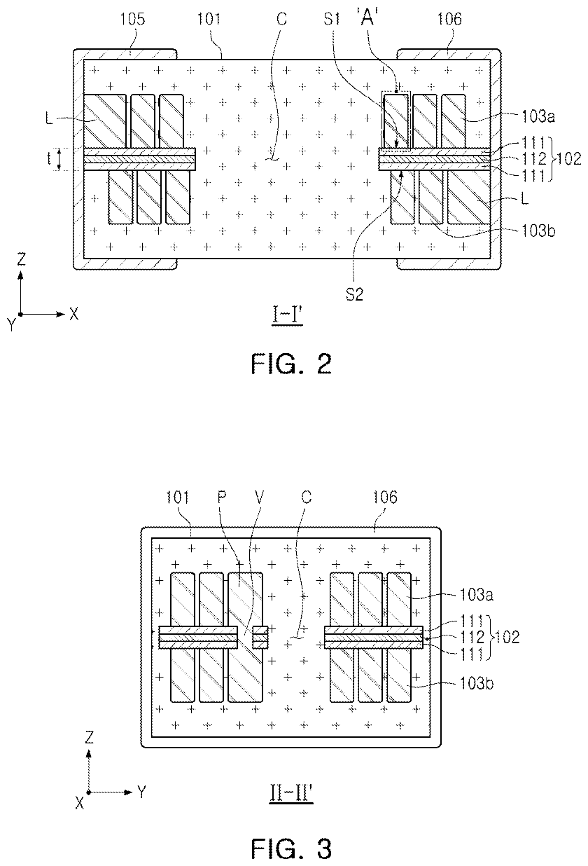

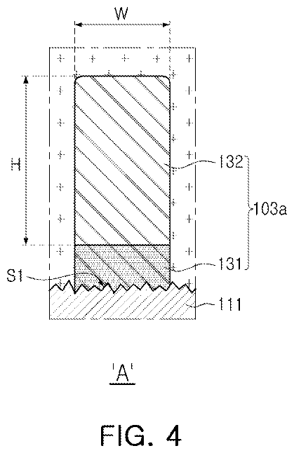

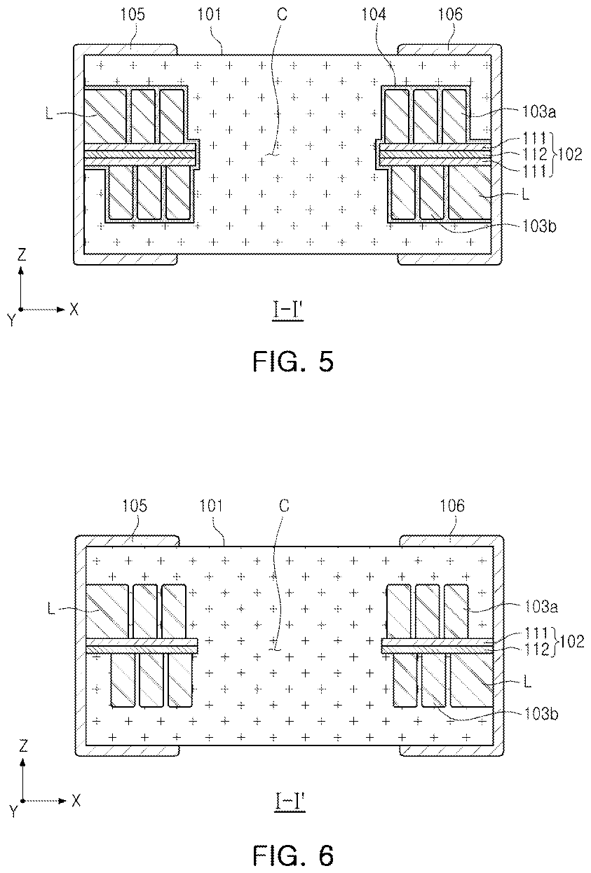

FIG. 1 is a transparent perspective view schematically illustrating a coil component according to an exemplary embodiment in the present disclosure. FIGS. 2 and 3 are cross-sectional views taken along lines II-I′ and II-II′ of FIG. 1, respectively. FIG. 4 is a partially enlarged view of FIG. 2. FIGS. 5 and 6 illustrate coil components according to modified examples.

Referring to FIGS. 1 to 4, the coil component 100 according to the present exemplary embodiment includes a body 101, a support member 102, a coil 103, and external electrodes 105 and 106, and here, the support member 102 includes a first layer 111 and a second layer 112 respectively including polyimide. In addition, an average surface roughness of surfaces S1 and S2 of the support member 102 on which the coil 103 is disposed may be 0.1 to 0.5 μm in Ra value, and due to this surface roughness condition, coupling force between the support member 102 and the coil 103 may be improved to enhance structural stability of the coil component 100. Hereinafter, major elements constituting the coil component 100 of the present exemplary embodiment will be described.

The body 101 includes the support member 102, the coil 103, etc. disposed therein, and may form the appearance of the coil component 100. In this case, the body 101 may be formed so that a partial region of a lead-out portion L connected to the coil 103 is exposed externally. As an example, the body 101 may be formed such that the coil component 100 with the external electrodes 105 and 106 formed thereon, which will be described below, according to the present exemplary embodiment has a length of 2.5 mm, a width of 2.0 mm, and a thickness of 1.0 mm, has a length of 2.0 mm, a width of 1.2 mm, and a thickness of 0.65 mm, has a length of 1.6 mm, a width of 0.8 mm, and a thickness of 0.8 mm, has a length of 1.0 mm, a width of 0.5 mm and a thickness of 0.5 mm, or has a length of 0.8 mm, a width of 0.4 mm, and a thickness of 0.65 mm, but is not limited thereto. Meanwhile, the aforementioned values are merely design values not reflecting process errors, etc., and thus, the range that may be recognized as a process error should be considered to fall within the scope of the present disclosure.

The length of the coil component 100 described above in a first direction (an X-direction) may refer to the maximum value among dimensions of a plurality of segments which connect two outermost boundary lines of the coil component 1 facing each other in the first direction (the X-direction) illustrated in an image of a cross-section of the coil component 100 in the first direction (the X-direction)-third direction (a Z-direction) in the center of the coil component 100 in a second direction (a Y-direction), captured by an optical microscope or a scanning electron microscope (SEM) and which are parallel to the first direction (the X-direction). Alternatively, the length of the coil component 100 described above in a first direction (an X-direction) may refer to the minimum value among the dimensions of the plurality of segments which connect two outermost boundary lines of the coil component 1 facing each other in the first direction (the X-direction) illustrated in the image of the cross-section of the coil component 100 and which are parallel to the first direction (the X-direction). Alternatively, the length of the coil component 100 described above in the first direction (the X-direction) may refer to an arithmetic average value of at least three of the dimensions of the plurality of segments which connect two outermost boundary lines of the coil component 1 facing each other in the first direction (the X-direction) illustrated in the image of the cross-section of the coil component 100 and which are parallel to the first direction (the X-direction). Here, the plurality of segments parallel to the first direction (the X-direction) may be equally spaced from each other in the third direction (the Z-direction), but the scope of the present disclosure is not limited thereto.

The length of the coil component 100 described above in the second direction (the Y-direction) may refer to the maximum value among the dimensions of a plurality of segments which connect two outermost boundary lines of the coil component 1 facing each other in the second direction (the Y-direction) illustrated in the image of the cross-section of the coil component 100 in the first direction (the X-direction)-second direction (the Y-direction) in the center of the coil component 100 in a second direction (a Y-direction), captured by an optical microscope or a scanning electron microscope (SEM) and which are parallel to the second direction (the Y-direction). Alternatively, the length of the coil component 100 described above in the second direction (the Y-direction) may refer to the minimum value among the dimensions of the plurality of segments which connect two outermost boundary lines of the coil component 1 facing each other in the second direction (the Y-direction) illustrated in the image of the cross-section of the coil component 100 and which are parallel to the second direction (the Y-direction). Alternatively, the length of the coil component 100 described above in the second direction (the Y-direction) may refer to an arithmetic average value of at least three of the dimensions of the plurality of segments which connect two outermost boundary lines of the coil component 1 facing each other in the second direction (the Y-direction) illustrated in the image of the cross-section of the coil component 100 and which are parallel to the second direction (the Y-direction). Here, the plurality of segments parallel to the second direction (the Y-direction) may be equally spaced from each other in the first direction (the X-direction), but the scope of the present disclosure is not limited thereto.

The length of the coil component 100 described above in the third direction (the Z-direction) may refer to the maximum value among the dimensions of a plurality of segments which connect two outermost boundary lines of the coil component 1 facing each other in the third direction (the Z-direction) illustrated in the image of the cross-section of the coil component 100 in the first direction (the X-direction)-third direction (the Z-direction) in the center of the coil component 100 in the third direction (the Z-direction), captured by an optical microscope or a scanning electron microscope (SEM) and which are parallel to the third direction (the Z-direction). Alternatively, the length of the coil component 100 described above in the third direction (the Z-direction) may refer to the minimum value among the dimensions of the plurality of segments which connect two outermost boundary lines of the coil component 1 facing each other in the third direction (the Z-direction) illustrated in the image of the cross-section of the coil component 100 and which are parallel to the third direction (the Z-direction). Alternatively, the length of the coil component 100 described above in the third direction (the Z-direction) may refer to an arithmetic average value of at least three of the dimensions of the plurality of segments which connect two outermost boundary lines of the coil component 1 facing each other in the third direction (the Z-direction) illustrated in the image of the cross-section of the coil component 100 and which are parallel to the third direction (the Z-direction). Here, the plurality of segments parallel to the third direction (the Z-direction) may be equally spaced from each other in the first direction (the X-direction), but the scope of the present disclosure is not limited thereto.

Meanwhile, each of the lengths of the coil component 100 in the first to third directions may be measured using a micrometer measurement method. According to the micrometer measurement method, the lengths of the coil component 100 in the first to third directions may be measured by setting a zero point by a micrometer with Gage Repeatability and Reproducibility (R&R), inserting the coil component 100 according to the present exemplary embodiment between the tips of the micrometer, and then turning a measurement lever of the micrometer. Meanwhile, when measuring the length of the coil component 100 using the micrometer measurement method, the length of the coil component 100 may refer to a value measured once or an arithmetic average of values measured multiple times.

The body 101 may include an insulating resin and a magnetic material. Specifically, the body 101 may be formed by stacking one or more magnetic composite sheets in which a magnetic material is dispersed in an insulating resin. The magnetic material may be ferrite or magnetic metal powder. Ferrites may include at least one of, for example, spinel-type ferrites, such as Mg—Zn-based, Mn—Zn-based, Mn—Mg-based, Cu—Zn-based, Mg—Mn—Sr-based, Ni—Zn-based ferrites, hexagonal ferrites, such as Ba—Zn-based, and Ba—Mg-based, Ba—Ni-based, Ba—Co-based, and Ba—Ni—Co-based ferrites, and a garnet-type ferrite, such as Y-based ferrite, and Li-based ferrite. Magnetic metal powder may include one or more selected from the group consisting of iron (Fe), silicon (Si), chromium (Cr), cobalt (Co), molybdenum (Mo), aluminum (Al), niobium (Nb), copper (Cu), and nickel (Ni). For example, magnetic metal powder includes pure iron powder, Fe—Si alloy powder, Fe—Si—Al alloy powder, Fe—Ni alloy powder, Fe—Ni—Mo alloy powder, Fe—Ni—Mo—Cu-based alloy powder, Fe—Co-based alloy powder, Fe—Ni—Co-based alloy powder, Fe—Cr-based alloy powder, Fe—Cr—Si-based alloy powder, Fe—Si—Cu—Nb-based alloy powder, Fe—Ni—Cr-based alloy powder and Fe—Cr—Al-based alloy powder. Magnetic metal powder may be amorphous or crystalline. For example, the magnetic metal powder may be Fe—Si—B—Cr-based amorphous alloy powder, but is not limited thereto. Ferrite and magnetic metal powder may each have an average diameter of about 0.1 μm to 30 μm, but are not limited thereto. The body 101 may include two or more types of magnetic materials dispersed in a resin. Here, the different types of magnetic materials may refer to the magnetic materials dispersed in a resin that are distinguished from each other by any one of average diameter, composition, crystallinity, and shape. Meanwhile, the following description will be given on the premise that the magnetic material is magnetic metal powder, but the scope of the present disclosure is not limited only to the body 101 having a structure in which magnetic metal powder is dispersed in an insulating resin. The insulating resin may include epoxy, polyimide, liquid crystal polymer, etc., alone or in combination, but is not limited thereto.

Meanwhile, the body 101 may include a core C penetrating through the center of the support member 102 and the coil 103. The core C may be formed by filling a through-hole penetrating through the center of the coil 103 and the center of the support member 102 with a magnetic composite sheet including a magnetic material.

The support member 102 may be disposed inside the body 101 and may support the coil 103. In the case of the present exemplary embodiment, the support member 102 includes a first layer 111 and a second layer 112, respectively including polyimide. Regarding a material of the support member 102, a commonly used insulating layer, such as prepreg, includes a reinforcing material, such as glass fiber, and in this case, there is a limit to reducing the thickness of the support member 102. In the present exemplary embodiment, the support member 102 formed of polyimide suitable for miniaturization is used. Specifically, a thickness t of the support member 102 may be 5 μm or more and less than 15 μm, and more preferably, 5 μm or more and less than 10 μm. The thickness t is significantly smaller than that of the support member used in the related art coil components, which is tens of μm. The reduction in the thickness t of the support member 102 may lead to a reduction in the thickness of the coil component 100, and further, a sufficient cover region of the body 101 may be secured, thereby smoothing the flow of magnetic flux. The thickness t may be measured by an optical microscope or a scanning electron microscope (SEM). Other methods and/or tools appreciated by one of ordinary skill in the art, even if not described in the present disclosure, may also be used.

As described above, the support member 102 has a multilayer structure and specifically includes the first layer 111 and the second layer 112 respectively including polyimide. In the case of using the first and second layers 111 and 112 of different materials, the thickness of the support member 102 may be appropriately implemented as intended. Furthermore, by applying materials having different characteristics depending on the region of the support member 102, the characteristics of the coil component 100 may be optimized. In this case, as shown, the support member 102 may include a plurality of first layers 111, and the second layer 112 may be disposed between the plurality of first layers 111. In this case, the first layer 111 and the second layer 112 may have the same thickness, but, if necessary, they may be designed to have different thicknesses. The coils 103 may be disposed on surfaces of the plurality of first layers 111, and the aforementioned surface roughness conditions may be applied to the surface of the first layer 111. In a specific example, the first layer 111 may be a thermoplastic polyimide layer, and the second layer 112 may be a polyimide layer. The structural stability of the support member 102 may be improved by using a thermoplastic polyimide layer having excellent chemical resistance as the first layer 111 disposed on the outermost side of the support member 102. In the present exemplary embodiment, the support member 102 has a three-layer structure including two first layers 111 and one second layer 112, but depending on the exemplary embodiment, the substrate 102 may have a structure of four or more layers including a plurality of first layers 111 and a plurality of second layers 112 or may be implemented to have a two-layer structure as in a modified example to be described below.

In the case of the present exemplary embodiment, the average surface roughness of the surfaces S1 and S2 of the support member 102 on which the coil 103 is disposed may be 0.1 to 0.5 μm in Ra value, based on which the support member 102 may be stably coupled to the coil 103. If the thickness t of the support member 102 decreases, support force of the coil 103 may decrease, and which may be more problematic when the coil 103 is formed thick to secure sufficient characteristics. According to present inventor's experiments, outside the aforementioned illumination conditions, for example, when Ra is less than 0.1 μm, it was difficult to sufficiently secure the height H of the coil 103 (e.g., 80 μm or more) due to a problem of adhesion with the coil 103. By satisfying the surface roughness conditions of the present exemplary embodiment, the height H and aspect ratio of the coil 103 may be sufficiently secured. As a specific example, an average width W of the coil 103 may be 80 μm or less, and an average aspect ratio H/W of the coil 103 may be greater than 2. The average width W and the height H may be measured by an optical microscope or a scanning electron microscope (SEM). Other methods and/or tools appreciated by one of ordinary skill in the art, even if not described in the present disclosure, may also be used.

As an additional limitation of the surface roughness condition to further improve support force of the support member 102, the average surface roughness of the surfaces S1 and S2 on which the coil 103 is disposed in the support member 102 may be 1.0 to 2.5 μm in Rz value. Meanwhile, the roughness Ra or Rz of the support member 102 may be calculated by selecting a plurality of regions in one or more cross-sections corresponding to FIG. 2 or 3 in the support member 102. Specifically, a surface profile is selected from a sample region having a length of about 50 μm to 150 μm in a cut plane (a X-Z plane in FIG. 2 and a Y-Z plane in FIG. 3) perpendicular to the surfaces S1 and S2 on which the coil 103 is disposed in the support member 102. An average value of a distance from a virtual center line in this sample region may be defined as roughness (Ra) by the center line average calculation method, and here, the sum of the distances from the virtual center line may correspond to the area between the surface profile and the virtual center line. Also, the virtual center line may be set to be midway between the highest and lowest surface roughness regions. Next, in the case of roughness Rz using a ten-point average calculation method, it may be obtained by adding an average value of the five distances farthest upwardly from the virtual center line and an average value of the five distances farthest downwardly from the virtual center line. In addition, the width W and height H of the coil 103 may also be obtained through one or more cross-sections corresponding to FIG. 2 or 3, and the height of the coil 103 may be a value measured from a concave portion located on the outermost side in an uneven portion forming surface roughness. Other methods and/or tools appreciated by one of ordinary skill in the art, even if not described in the present disclosure, may also be used.

The coil 103 may have a spiral structure forming one or more turns, and may be formed on at least one of the surfaces S1 and S2 of the support member 102. The present exemplary embodiment illustrates an example in which the coil 103 includes first and second coils 103a and 103b respectively disposed on two opposing surfaces S1 and S2 of the support member 102. In this case, the first and second coils 103a and 103b may include a pad P and may be connected to each other by a conductive via V penetrating through the support member 102. The lead-out portion L may be disposed at the outermost portion of the coil 103, may provide a connection path with the external electrodes 105 and 106, and may be formed as an integrated structure with the coil 103. In this case, as illustrated, for connection to the external electrodes 105 and 106, the lead-out portion L may be implemented to have a wider width than the coil 103, and here, the width refers to the width in the X direction in FIG. 1.

As shown in FIG. 4, the coil 103 may have a multilayer structure including a first coil layer 131 and a second coil layer 132, and in FIG. 4, the first coil 103a is illustrated, but the second coil 103b may also have a multilayer structure. The first coil layer 131 may be in contact with the surfaces S1 and S2 of the support member 102, and further, the first coil layer 131 may fill the uneven portion of the surfaces S1 and S2 of the support member 102. The first coil layer 131 may be a sputtering layer and may be a seed layer for forming the second coil layer 132. However, the first coil layer 131 may be an electroless plating layer, in addition to a sputtering layer. The first coil layer 131 may be formed of a conductive material, such as molybdenum (Mo), copper (Cu), aluminum (Al), silver (Ag), tin (Sn), gold (Au), nickel (Ni), lead (Pb), titanium (Ti), chromium (Cr), or alloys thereof. The first coil layer 132 may be a plating layer, for example, an electroplating layer. Here, the electroplating layer may have a single-layer structure or a multilayer structure. The electroplating layer having a multilayer structure may be formed as a conformal film structure in which another electroplating layer is formed along a surface of one electroplating layer, and may be configured such that the other electroplating layer is stacked only on one surface of one electroplating layer.

The external electrodes 105 and 106 may include a plurality of external electrodes respectively connected to both ends of the coil 103, and may include first and second external electrodes 105 and 106 as illustrated. The first and second external electrodes 105 and 106 may be spaced apart from each other on the body 101 and connected to both ends of the coil 103, respectively. The external electrodes 105 and 106 may be formed by a vapor deposition method, such as sputtering and/or a plating method, but are not limited thereto. The external electrodes 105 and 106 may be formed of a conductive material, such as copper (Cu), aluminum (Al), silver (Ag), tin (Sn), gold (Au), nickel (Ni), lead (Pb), chromium (Cr), and titanium (Ti), or alloys thereof, but are not limited thereto. The external electrodes 105 and 106 may be formed to have a single-layer or multilayer structure. For example, the external electrodes 105 and 106 may include a first conductive layer including copper (Cu), a second conductive layer disposed on the first conductive layer and including nickel (Ni), and a third conductive layer disposed on the second conductive layer and including tin (Sn). At least one of the second conductive layer and the third conductive layer may be formed to cover the first conductive layer, but the scope of the present disclosure is not limited thereto. The first conductive layer may be a plating layer or a conductive resin layer formed by applying and curing a conductive resin including a resin and a conductive powder including at least one of copper (Cu) and silver (Ag). The second and third conductive layers may be plating layers, but the scope of the present disclosure is not limited thereto.

A coil component according to a modified exemplary embodiment will be described with reference to FIGS. 5 and 6. First, as in the exemplary embodiment of FIG. 5, an 6 insulating film 104 may be formed on the surface of the coil 103. The insulating film 104 may integrally cover the coil 103 and the support member 102. Specifically, the insulating film 104 may be disposed in regions, such as between the coil 103 and the body 101 and between the support member 102 and the body 101. The insulating film 104 may be formed along the surface of the support member 102 on which the coil 103 is formed, but is not limited thereto. The insulating film 104 may be formed to fill a region, such as between adjacent turns of the coil 103. The insulating film 104 may serve to electrically separate the coil 103 from the body 101 and may include a known insulating material, such as parylene, but is not limited thereto. As another example, the insulating film 104 may include an insulating material, such as an epoxy resin, rather than parylene. The insulating film 104 may be formed by a vapor deposition method, but is not limited thereto. As another example, the insulating film 104 may be formed by stacking and curing an insulating film for forming the insulating film 104 on both surfaces of the support member 102 on which the coil 103 is formed, or may also be formed by applying and curing an insulating paste for forming the insulating film 104 on both surfaces of the support member 102 on which the coils 311 and 312 are formed.

Next, as in the exemplary embodiment of FIG. 6, the support member 102 may have a two-layer structure, that is, a structure including one first layer 111 and one second layer 112, which may be advantageous to further reduce the thickness of the support member 102. As the support member 102 has a two-layer structure, the coil 103 may be placed on the surface of each of the first layer 111 and the second layer 112, and the aforementioned surface roughness conditions may be applied to the surface of each of the first layer 111 and the second layer 112.

According to the present disclosure, the coil component that is advantageous to miniaturization and has improved structural stability may be implemented.

While example exemplary embodiments have been shown and described above, it will be apparent to those skilled in the art that modifications and variations could be made without departing from the scope of the present disclosure as defined by the appended claims.

What is claimed is:

1. A coil component comprising:
a body;
a support member disposed within the body, the support member having a first surface and a second surface opposing each other;
a coil disposed on at least one of the first surface and the second surface of the support member; and
an external electrode disposed on the body and connected to the coil,
wherein
the support member includes a first layer and a second layer respectively including polyimide, and
a first average surface roughness, Ra, of the surface of the support member on which the coil is disposed is 0.1 to 0.5 μm.

2. The coil component according to claim 1, wherein a thickness of the support member is 5 μm or more and less than 10 μm.

3. The coil component according to claim 1, wherein the support member includes a plurality of the first layers.

4. The coil component according to claim 3, wherein the second layer is disposed between the plurality of first layers.

5. The coil component according to claim 4, wherein the coil is disposed on a surface of the plurality of first layers.

6. The coil component according to claim 4, wherein the first layer is a thermoplastic polyimide layer.

7. The coil component according to claim 6, wherein the second layer is a polyimide layer.

8. The coil component according to claim 1, wherein a second average surface roughness, Rz, of the surface of the support member on which the coil is disposed is 1.0 to 2.5 μm.

9. The coil component according to claim 1, wherein the coil has a multilayer structure including a first coil layer and a second coil layer.

10. The coil component according to claim 9, wherein the first coil layer is in contact with the at least one of the first surface and the second surface of the support member.

11. The coil component according to claim 10, wherein the first coil layer fills an uneven portion of the at least one of the first surface and the second surface of the support member.

12. The coil component according to claim 10, wherein the first coil layer is a sputtered layer.

13. The coil component according to claim 12, wherein the second coil layer is a plated layer.

14. The coil component according to claim 1, wherein an average width of the coil is 80 μm or less.

15. The coil component according to claim 1, wherein an average aspect ratio of the coil is greater than 2.

16. A coil component comprising:
a body;
a support member disposed within the body, the support member having a first surface and a second surface opposing each other;
a coil disposed on at least one of the first surface and the second surface of the support member; and
an external electrode disposed on the body and connected to the coil,
wherein
the support member includes a first layer and a second layer respectively including polyimide, and
an average surface roughness, Rz, of the surface of the support member on which the coil is disposed is 1.0 to 2.5 μm.

17. The coil component according to claim 16, wherein the first layer and the second layer have the same thickness.

18. The coil component according to claim 17, wherein a thickness of the support member is 5 μm or more and less than 10 μm.

19. The coil component according to claim 16, wherein the first layer includes a thermoplastic polyimide layer.
